(19) United States
(12) Patent Application Publication
(10) Pub. No.: US 2004/0043684 A1
(43) Pub. Date: Mar. 4, 2004

(54) Method for the production of fabric inserts for synthetic resin-bonded formed bodies as well as impregnation agent for fabric inserts

(76) Inventors: Heinz-Juergen Dern, Menden (DE); Volker Stehl, Altena (DE)

Correspondence Address: Charles A. Muserlian, Muserlian, Lucas and Mercanti, 600 Third Avenue, New York, NY, 10016, US

(21) Appl. No.: 10/612,606

(22) Filed: Jul. 2, 2003

(30) Foreign Application Priority Data
Jul. 5, 2002 (DE) 102 30573.0

(51) Int. Cl. B32B 5/02

(52) U.S. Cl. 442/59

(57) ABSTRACT

A method for the production of fabric inserts, impregnated with a thermosetting binding agent or binding agent mixture, for synthetic resin-bonded formed bodies, and an additive from the group of fatty acid amides or substituted fatty acid amides is added before the impregnation to the binding agent or binding agent mixture utilized for the impregnation.

A method for the production of fabric inserts, impregnated with thermosetting binding agents or binding agent mixtures, for synthetic resin-bonded formed bodies, in particular for grinding wheels, as well as impregnating agent for fabric inserts.

### STATE OF THE ART

As a rule, synthetic resin-bonded formed bodies are produced by compressing and subsequently curing a fabric insert, provided with a thermosetting resin, with a formed body material comprised of binding agent, filler and additive substances. The technically most important synthetic resin-bonded formed bodies with fabric inserts are grinding wheels.

For their production the fabric insert, impregnated with the thermosetting binding agent or binding agent mixture, is prefabricated, which means, a fabric is impregnated with a thermosetting resin or resin mixture or with a mixture of a latent curing agent and a thermosetting resin or a resin mixture, and the resin is dried and optionally precured to the extent that it is no longer flowable but still capable of reacting with the binding agent of the grinding body material and of cross-linking to form a uniform polymer system at the curing temperatures of the grinding tools (cf. Gardziella, Pilato, Knop “Phenolic Resins”, Springer Verlag 2000, pp. 333-336). Unfortunately, even the dried resin is not absolutely free of tack. On the other hand, the prefabricated fabric inserts, optionally already stamped to form disks, are stacked and transported and stored as stacks. The individual fabric inserts adhere again with one another and must be manually separated again before they can be applied.

To ensure the faultless separation of the fabric inserts, usually a separating sheet, preferably a silicon paper, is introduced between each fabric insert, which accumulates as waste after each singulation. This is expensive, on the one hand, and requires additional expenditures for the work, which is uncomplainingly performed by automata, which, however, with the manual insertion leads to an enormous additional burden on the employees.

The method, which suggests itself to the person skilled in the art, for attaining a separating effect of the fabric inserts by addition of conventional waxes to the impregnating resin cannot be used since these additives also act as separating agents with respect to the grinding material and consequently cause a degradation of the strength of the resulting grinding wheels.

### OBJECTS OF THE INVENTION

It is an object of the invention to provide a method of production of fabric inserts impregnated with a thermosetting binding agent or mixture thereof for synthetic resin-bonded formed bodies which can be stacked without adherence or using a separating sheet.

It is another object of the invention to provide a thermosetting binding agent or mixture thereof and at least one additive of fatty acid amides and/or substituted fatty acid amides.

These and other objects and advantages of the invention will become obvious from the following detailed description.

### THE INVENTION

In the method for the production of synthetic resin-bonded formed bodies using fabric inserts impregnated with a thermosetting binding agent or mixture, the improvement of the invention comprises adding at least one fatty acid amide and/or substituted fatty acid amide to the thermosetting binding agent or mixture before the impregnation. The invention is particularly useful for grinding wheels as the formed bodies.

The novel impregnating agents of the invention are comprised of at least one thermosetting binding agent in liquid form containing 1 to 15% by weight of at least one fatty acid amide and/or substituted fatty acid amide.

The fiber inserts impregnated with an impregnating agent of the invention can be stacked without the use of a separating sheet and which do not adhere to each other. After storage, they can be used by simply and reliably separating the same to prepare the same quality of formed bodies obtained when using fabric inserts stacked with use of separating sheets. The fabric inserts of the invention can be stacked without any problems and even after storage at elevated temperatures, they can be easily separated and used to produce formed bodies such as grinding wheels of excellent quality.

At ambient temperature, the added additives from the group of fatty acid amides or substituted fatty acid amides are solid to semisolid substances or substance mixtures of the formula:

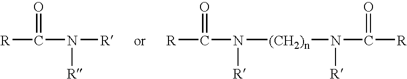

wherein

n is an integer of 1 to 6

R is alkyl of 10 to 30 carbon atoms,

and R′ and R″ are individually hydrogen of 1 to 6 carbon atoms. Preferred compounds are oleamide, behenamide, steramide and are preferably ethylene bis-stearamide.

If fabrics are impregnated with thermosetting resins or mixtures of latent curing agents and thermosetting resin (binding agents or binding agent mixtures) containing the amides, these additives act as separating means between the individual layers of the impregnated fabrics and prevent their adhesion when they are stacked. But surprisingly, these additives do not act as separating means between the thermosetting binding agent or mixtures and the fabric, so that after the curing, faultless bonding is obtained, and they also do not act as a separating means between the fabric insert and the grinding material molded with it, such that after the curing, a completely homogeneous cross-linking between the impregnating resin of the fabric and the binding agent of the grinding body material is obtained and therewith the desired strength and durability of the grinding wheel.

The effect of the additives from the group of fatty acid amides or substituted fatty acid amides to impregnation resins, and consequently also the production of the invention of the corresponding fabric inserts, cannot only be employed in the production of grinding wheels but also generally in the production of synthetic resin-bonded formed bodies which are reinforced with fabric inserts.

The use of such products from the group of fatty acid amides or substituted fatty acid amides with epoxy resins or phenolic resins is known per se. Such fatty amides serve, for example according to JP-A 10130462 (C.A. 129:55251), as separating means in epoxy resin formulations.

Binding agents of phenolic resins combined with substituted and unsubstituted fatty acid amides are principally described as binding agents for sand in the production of molds in the casting industry [JP-A 60111734 (C.A. 103:182359) or JP-A 57209741 (C.A. 98:165573)]. According to an investigation of the effect of additives on the following and curing properties of phenolic resin molding compounds (C.A. 104:34743), it was found that with an increasing content of separating agents, the flowability is increased, but also that with increasing amounts of, for example, ethylene bis-stearyl amide, the through-curing rate is impaired. Thus, a person skilled in the art would expect that the strength of the grinding wheels produced with these additives also decreases.

In the inventive method, the products from the group of fatty acid amides or substituted fatty acid amides are added to the binding agent or binding agent mixture (impregnating resin) in amounts of 1 to 15 wt. % preferably 3 to 5 wt. %, relative to the amount of the impregnating resin. Many of these fatty acid amides or substituted fatty acid amides are not methanol soluble and therefore, as a rule, cannot be worked into the binding agents used according to the invention. The addition therefor preferably takes place in the form of a dispersion which permits the stable incorporation into the methanolic binding agent mixture.

As thermosetting binding agents or binding agent mixtures for the molding body materials, particularly grinding body materials, there can be used solid powdered resins, known per se for these mixtures, based on phenol, alkylphenol, epoxide, polyester or polyurethane resins but also coating powders and reactive group-containing coating powder residues as well as liquid resins and mixtures of solid and liquid thermosetting resins, which, together with a latent curing agent, are used in amounts of 5 to 20 wt. %, preferably about 10 wt. %, relative to the total weight of the molding body material

Preferred thermosetting resins are novolaks and the preferred latent curing agent for the novolaks is hexamethylene tetramine, which is mixed into the novolak in amounts of 3 to 16 wt. % relative to the weight of the novolak. Examples of novolaks which can be utilized include all condensation products produced in an acidic medium of phenolic compounds and an aldehyde, particularly formaldehyde, at a molar ratio of phenolic compounds to aldehyde of 1:0.9 to 1:0.2 and a melting point of 50 to 110° C.

Examples of phenolic compounds which can be used are mono- or polycyclic phenols or mixtures of said compound class, and specifically mono- as well as also polycyclic phenols. Examples of these are phenol itself, as well as its alkyl-substituted homologs such as o-, m- or p-cresol, xylenes or higher alkylated phenols, as well as halogen-substituted phenols, such as chloro- or bromophenol and multivalent phenols such as resorcinol or pyrocatechol and polycyclic phenols such as naphthols, bisphenol A or bisphenol F.

Phenol, or the phenolic compound, is converted to the desired novolak with aldehyde, particularly with formaldehyde, or a compound splitting off formaldehyde. The novolaks can be modified by conventional modification means, such as epoxy resins, rubber, polyvinylbutyral and inorganic additives.

For impregnating the fabric inserts, in principle the same types of binding agents are used as the binding agents of the molding body materials. If they are not the same binding agent or binding agent mixtures, they are selected so that they cross-link with the binding agents of the molding body material and that, as much as possible, they cure at the same temperature and same time period. The binding agents used for the impregnation must be in liquid form, i.e. either as liquid resin or as solution or dispersion. As a rule, methanolic solutions are used and specifically, resol as well as also novolak solutions and solutions containing resol and novolak.

To the binding agents or binding agent mixtures, used as impregnating resin, are added before the impregnation process 1 to 15 wt. % of one or several products from the group of fatty acid amides or substituted fatty acid amides and therewith a novel impregnating agent for fabric inserts is produced. With this impregnating agent, the impregnation of the fabric is carried out in a manner known per se.

The impregnating agents of the invention for the production of impregnated fabric inserts for synthetic resin-bonded formed bodies are therefor mixtures which comprise a thermosetting binding agent in liquid form and 1 to 15 wt. % of one or several fatty acid amides or substituted fatty acid amides, optionally, in addition to further auxiliary agents and additive substances.

The thermosetting binding agent is either a thermosetting resin or resin mixture or a mixture of resin and curing agent. The preferred thermosetting resin is either a resol, a novolak or a mixture of novolak and curing agent. The preferred thermosetting resin mixture is a resol-novolak mixture in any ratio of the components with respect to one another. The thermosetting binding agent is either a liquid resin or a solution of a thermosetting resin, resin mixture or a resin-curing agent mixture, with the preferred solvent being an alcohol, preferably methanol. The employed products from the group of fatty acid amides or substituted fatty acid amides are preferably aqueous dispersions of these products.

The fabrics to be impregnated can be comprised of natural and synthetic, inorganic and organic fibers. The preferred fabrics are glass fiber fabrics.

The fabric inserts, impregnated, dried and optionally, precured and stamped according to the invention, can be stacked without the use of further separating or auxiliary means and can be stored in stacks and when utilized can be separated simply and without problems to be subsequently employed in a manner known per se for the production of synthetic resin-bonded formed bodies, preferably grinding wheels.

It is to be understood that modifications of the compositions and method of the invention may be made without departing from the spirit or scope thereof and it is to be understood that the invention is to be limited only as defined in the appended claims.

What we claim is:

1. In the method for the production of synthetic resin-bonded formed bodies using fabric inserts impregnated with a thermosetting binding agent or mixture, the improvement of the invention comprises adding at least one fatty acid amide and/or substituted fatty acid amide to the thermosetting binding agent or mixture before the impregnation.

2. The method of claim 1 wherein the binding agent or mixture contains 1 to 15% by weight of fatty acid amides and/or substituted fatty acid amides.

3. The method of claim 1 wherein ethylene bis-stearylamide is the fatty acid amide.

4. The method of claim 1 wherein the binding agent is a resol.

5. The method of claim 1 wherein the binding agent is a novolak or a mixture of novolak and a curing agent.

6. The method of claim 1 wherein the binding agent is a mixture of a resol and a novolak.

7. The method of claim 1 wherein the binding agent and fatty acid amides are used as a dispersion.

8. A fabric insert used for production of synthetic resin-bonded bodies comprising a fabric insert impregnated with a thermosetting binding agent or mixture containing 1 to 15% by weight of a fatty acid amide or substituted fatty acid amide.

9. A grinding wheel formed with a fabric insert of claim 8.

10. An impregnating agent for the production of impregnating fabric inserts for resin bonded shaped bodies comprising a liquid thermosetting binding agent containing 1 to 15% by weight of fatty acid amides and/or substituted fatty acid amides.

11. An impregnating agent of claim 10 wherein the thermosetting binding agent is a resol.

12. An impregnating agent of claim 10 wherein the thermosetting binding agent is a novolak or a mixture of a novolak, and a curing agent.

13. The impregnating agent of claim 10 wherein the thermosetting binding agent is a resol-novolak mixture.

14. The impregnating agent of claim 10 wherein the thermosetting binding agent is in a methanol solution.

15. The impregnating agent of claim 10 wherein the amides are in an aqueous dispersion.
